(19) United States
(12) Patent Application Publication
(10) Pub. No.: US 2025/0014156 A1
(43) Pub. Date: Jan. 9, 2025

(54) METHOD FOR ANALYSING THE LUMINANCE DISTRIBUTION OF LIGHT EMANATING FROM AN ILLUMINATION DEVICE FOR A VEHICLE

(71) Applicant: HELLA GmbH & Co. KGaA, Lippstadt (DE)

(72) Inventors: Mathias NIEDLING, Lippstadt (DE); Katrin SCHIER, Paderborn (DE)

(73) Assignee: HELLA GmbH & Co. KGaA, Lippstadt (DE)

(21) Appl. No.: 18/834,166

(22) PCT Filed: May 25, 2022
(86) PCT No.: PCT/EP2022/064222

§ 371 Date: Jul. 29, 2024

(30) Foreign Application Priority Data
Jun. 2, 2021 (DE) 10 2021 114 301.2
Jan. 27, 2022 (DE) 10 2022 101 854.7

(51) Int. Cl. G06T 5/94; G06T 7/00

(52) U.S. Cl. CPC G06T 5/94; G06T 7/0002

(57) ABSTRACT

A method for analyzing the luminance distribution of light emanating from an illumination device for a vehicle. A digital image that corresponds to a luminance distribution of light emanating from an illumination device of a vehicle is recorded. The digital image is modified such that the modified image is a reconstruction of the luminance distribution, the reconstruction containing at least substantially still only the elements or parts of the luminance distribution that are perceptible to humans.

The present invention relates to a method for analyzing a luminance distribution of the light emanating from a lighting device for a vehicle.

Defective pixels of high-resolution modules are not always visible to the human observer, since they may be outshone by the surrounding pixels. However, if they are visible, they may distract the driver, which may result in an increased safety risk. Visible pixel errors result in an unintended change in the light image, and may greatly diminish the subjective impression of the product quality. It is not possible, based on the absolute difference in light densities between the defect and the surroundings, to predict whether a defective pixel will result in a visible change in the light image, and whether this represents a more complicated problem than is recognizable at first glance.

It would be desirable to have a methodology for predicting the visibility of defective pixels in the light image of a lighting device for a vehicle.

Therefore, the object underlying the present invention is to provide a method of the type stated at the outset which allows a conclusion to be drawn concerning the perceivability of elements or portions of a luminance distribution by a human.

This is achieved according to the invention by a method of the type stated at the outset having the features of claim 1. The subclaims relate to preferred embodiments of the invention.

According to claim 1, the method is characterized by the following method steps:
recording a digital image that corresponds to a luminance distribution of the light emanating from a lighting device of a vehicle,
modifying the digital image in such a way that the modified image is a reconstruction of the luminance distribution in which at least essentially only the elements or portions of the luminance distribution that are perceivable by a human are contained.

Based on the modified image, it may be determined, for example, whether existing pixel errors of a high-resolution module of a lighting device result in a visible change in the light image. On this basis, it may then be decided whether, despite the pixel errors, the module of the lighting device may continue to be used, or whether the module must be replaced with another module.

It may be provided that the digital image is modified using an algorithm that simulates processing steps of the human visual system. Such an approach provides the option to draw comparatively reliable conclusions concerning the visibility of possible changes in the light image.

The algorithm, in particular in a first step, may simulate the change in an image due to the optical structure of a human eye. In addition, the algorithm, in particular in a second step, may simulate the processing of image information concerning contrast information, which is performed in particular by the human brain or by cell types in the retina. In addition, the algorithm, in particular in a third step, may determine a visibility threshold. The visibility threshold is used in particular to decide which elements or portions of the luminance distribution are perceivable by a human and which elements or portions of the luminance distribution are not perceivable by a human, wherein the elements or portions of the luminance distribution that are not perceivable by a human according to this decision are not incorporated into the modified image. It may thus be ensured that at least essentially only the elements or portions of the luminance distribution that are perceivable by a human are contained in the modified image. In particular, this involves an algorithm that is based on various perceptive-psychological models that simulate the first processing steps of the human visual system. The algorithm is preferably based on three individual submodels that are linked to one another in series. The result of the algorithm is a reconstruction of the luminance distribution in which only the elements that can be perceived by a human are contained.

There is an option to compare the modified digital image to an image generated from a setpoint luminance distribution of the lighting device, in particular in order to decide whether the light distribution that is generated by the lighting device corresponds to suitable specifications, taking into account the perceivability by a human.

It may be provided that the recording of the digital image is a luminance measurement or is converted into a luminance distribution. Via both options it may be ensured that the image to be modified corresponds to a luminance distribution of the light emanating from a lighting device of a vehicle.

There is an option that the lighting device is a taillight or a headlight, in particular a high-resolution headlight, that can generate a light distribution having a plurality of pixels. In particular for high-resolution headlights with modules having correspondingly complex designs, it has proven to be very advantageous, using the method according to the invention, to have a methodology for predicting the visibility of defective pixels in the light image.

The recorded digital image may, for example, be a recording of a headlight light distribution or a recording of a taillight. Corresponding recordings or luminance measurements may be used as input data of the model that is used. For example, the eye color and age of an observer as well as the spatial resolution of the luminance image may be used as additional input parameters.

The method allows the general prediction of the visibility of inhomogeneities in the light image of a lighting device, in particular without adapting the parameters to the specific surroundings. It may likewise be provided that the method allows the position of the inhomogeneity to be determined. Thus, one application of the method is prediction of the recognizability of defects in a headlight light distribution, for example.

The invention is explained in greater detail below with reference to the appended drawings, which show the following:

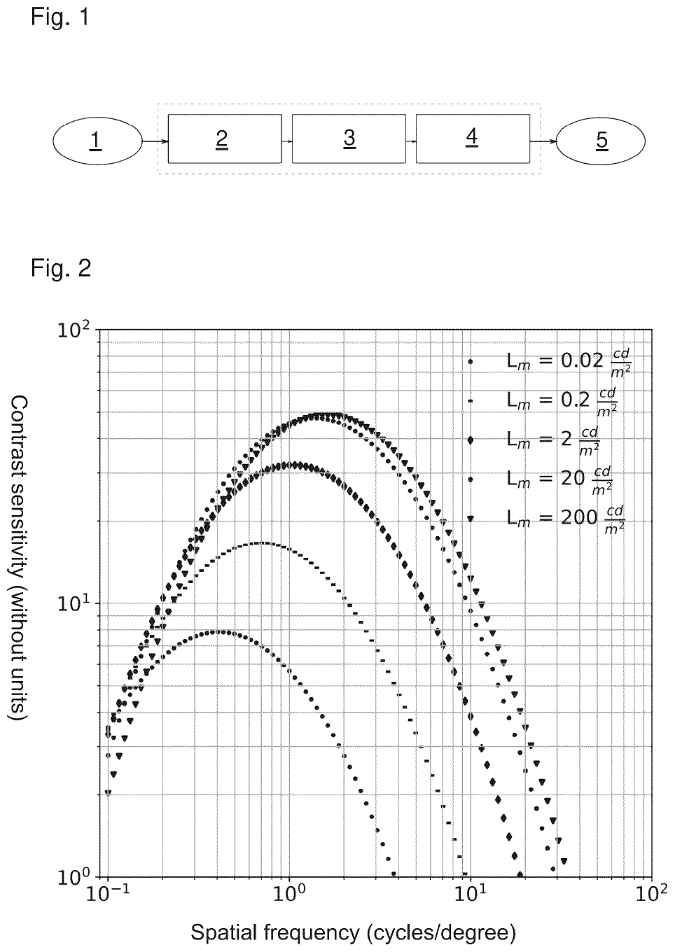

FIG. 1 shows a schematic illustration of one example of a method according to the invention;

FIG. 2 shows an example of an illustration of an optical contrast sensitivity function of the human eye, with the contrast sensitivity plotted as a function of the spatial frequency;

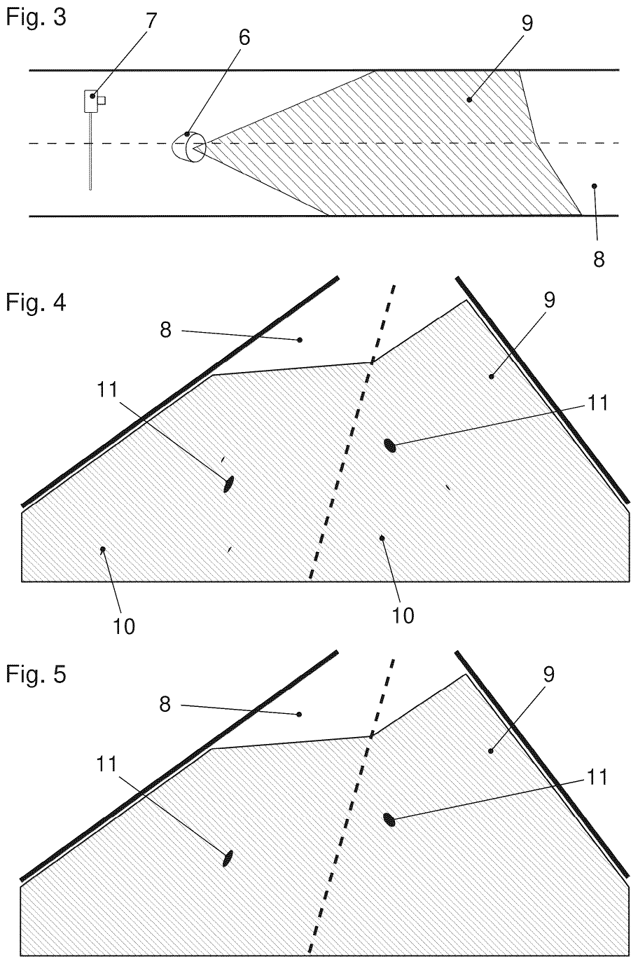

FIG. 3 shows an example of a test setup for recording an image that corresponds to a luminance distribution of the light emanating from a headlight;

FIG. 4 shows an example of an image that corresponds to a luminance distribution with pixel errors; and

FIG. 5 shows the image according to FIG. 4 after a change using a method according to the invention.

Identical and functionally equivalent parts and regions are provided with the same reference numerals in the figures.

High-resolution headlights allow the generation of lane and symbol projections, and thus provide additional information for the driver and other road users. While on the one hand there is an option to highlight individual pixels, the light pattern without projections should convey a uniform impression of the luminance distribution and have no noticeable differences in intensity between neighboring pixels. The particular differences in intensity that result in visible gaps in the light pattern depend on a number of parameters.

By use of a method according to the invention, a model for predicting the visibility of such intensity gaps for the human observer may be provided, which is a task that is directly linked to the contrast recognition. Therefore, the model can implement sequentially applied submodels that are based on the contrast sensitivity function (CSF).

The recognition of objects or spots in a setting that is illuminated by headlights is closely correlated with the contrast recognition. For roadway illumination, CIE Report 19/2 [1] proposes use of the degree of visibility, based on psychophysical data that have been measured by Blackwell [2], for predicting the recognizability of a target in illuminated surroundings. The degree of visibility is defined as the ratio of the contrast (between object and background) and the threshold contrast. Although it is a good measure for the recognizability of objects under laboratory conditions, for the problem that is solved within the scope of the present patent application it is not applicable due to the fact that a spot at an unknown position, and not an object, is to be recognized.

Blakemore and Campbell [3] have postulated that early visual processing mechanisms can be modeled via overlapping channels that are sensitive to different spatial frequencies. The authors introduced the reciprocal of the threshold contrast, referred to as the contrast sensitivity function (CSF). The contrast sensitivity function is measured by showing the observer images with sinusoidal gratings, since the frequency of these test patterns can be set very precisely.

The contrast sensitivity function is typically depicted in a diagram that indicates the contrast sensitivity as a function of the spatial frequency in cycles per degree (cyc/deg). The sensitivity also changes with the luminance. At lower luminances, the sensitivity decreases and the maximum sensitivity shifts to lower frequencies (see FIG. 2). Since the human visual system is very complex and even today is not fully understood, the contrast sensitivity function can be only a simplified model that is reduced to certain limitations. Nevertheless, it has been successfully used for various applications, for example quality measurements for image compression algorithms [4] or the assessment of the vision of patients after eye surgery [5].

Joulan et al. [6] were the first to use the contrast sensitivity function in the context of automotive lighting for predicting the visibility of objects that are illuminated by a headlight. The authors proposed application of a multiscale spatial filter, which simulates the simple contrast perception of human vision, to luminance images. The filter is made up of a weighted sum of Differential of Gaussians (DoG). The weights are adjusted so that the resulting filter corresponds to the contrast sensitivity function developed by Barten [7] However, Barten emphasizes that his CSF model is valid only for photopic vision. In contrast, night-time driving results in scenarios lying in the mesopic range.

In the example of the method according to the invention, an approach is used which splits the effects of the optical system of the eye (optical contrast sensitivity function) and the neural processing of the retinal image (neural contrast sensitivity function). The optical contrast sensitivity function involves effects such as blinding caused by scattered light. The neural contrast sensitivity function simulates the receptive fields of the early stages of the human visual cortex. A third portion, which induces the threshold value contrast sensitivity function, concludes the model and allows a prediction of the visibility of a contrast. The selected threshold value contrast sensitivity function is valid for mesopic vision.

The described example of a method according to the invention may be a model having a meaningful number of parameters. For this purpose the following boundary conditions may be taken into account:
The model is valid only for foveal vision, which encompasses angles of −2°≤α≤2° [8]. This also means that stimuli do not have to be recognized in the periphery before they are focused.
The contrast sensitivity is also a function of the presentation time of the visual stimulus [9]. For an observation time less than 4 s the contrast sensitivity is reduced. Here, only static scenarios are considered, and the observers are provided with more than 4 s for the stimuli. Therefore, the time dependency of the contrast sensitivity may be ignored.
The model in a first step is designed for achromatic light patterns.
The observation is always considered for a binocular view of the stimulus.
When contrasts having a certain frequency are considered for a period of approximately 1 minute, a contrast adaptation occurs [3] which reduces the contrast sensitivity for the adapted frequency range. This effect is not taken into account in the model. It is assumed that the observer has only approximately 30 s to observe the stimuli.
Special attention by the observer to certain regions results in higher contrast sensitivities [11]. This effect is not taken into account.

There is also an option to select other boundary conditions for the model.

The model is designed as input for digital images 1 that correspond to the luminance distributions or luminance images. According to the example of a method according to the invention, the digital image 1 is modified by use of an algorithm that simulates processing steps of the human visual system. The model includes the following submodels or method steps, which are applied in succession (see FIG. 1):
1. An optical contrast sensitivity function 2 that simulates the imaging errors by the optics of the human eye. These include, for example, effects such as blinding, which occurs due to scattering at the medium of the eye. In the example considered here, the model by Watson is implemented [12]. Thus, in a first step the algorithm simulates the change in an image due to the optical structure of a human eye.
2. A neural contrast sensitivity function 3 that simulates the contrast recognition mechanisms in the human retina. This is in particular a great simplification of the currently known processes that occur in the brain. In the example considered here, the CSF developed by Peli [13] is selected for the application. In a second step, the algorithm thus simulates the processing of image information concerning contrast information by the human brain.
3. A threshold value contrast sensitivity function 4 to which the results are compared. This model is used to determine the threshold on the basis of which it is decided which elements are still visible and which elements are not. In the example considered here, the contrast sensitivity function developed by Wuerger et al. is selected as best suited for the desired application. The contrast sensitivity function is designed for a large range of luminances, and is therefore valid for mesopic vision. In a third step, the algorithm thus determines a visibility threshold.

A block diagram of this model is illustrated in FIG. 1. The digital image 1 is modified in such a way that the modified image 5 is a reconstruction of the luminance distribution that contains at least essentially only the elements or portions of the luminance distribution that are perceivable by a human. Each submodel is explained in greater detail in the following paragraphs.

The optical contrast sensitivity function 2 describes the aberration of the image due to effects caused by the media of the eye. The optical contrast sensitivity function may be used to compute the resulting retinal image for a stimulus that is shown to a human observer [12]. Due to including the optical contrast sensitivity function 2 in the model, effects such as blinding are taken into account, which may have a great influence on the overall contrast sensitivity function.

The model implemented here was developed by Watson [12]. The size of the pupil, the age of the observer, and the eye color influence the aberration, and are therefore taken into account as input parameters for the model.

Watson used the data from a large number of wavefront aberration measurements for developing the model. Zernike polynomials up to the 35th order were used in adapting to the measured aberrations [12]. Based on the results, Watson computed an average radially symmetrical real modulation transfer function and approximated a function that best fit the data. In addition, the effect of scattered light is included, which reduces the contrasts. Watson used the formula developed by Ijspeert et al. 1993 to incorporate the influence of the scattered light.

As indicated in [12], Watson's model comes to the following conclusion:

$$CSF ( r , d ) = {[ 1 + {( \frac{r}{{u}_{1} ( d )} )}^{2} ]}^{- 0.62} \cdot \sqrt{D ( r , d , λ )} \cdot ( 1 - S ( a , p ) ) \qquad ( 1 )$$

where r=\sqrt{u²+v²}, u is the horizontal spatial frequency, and v is the vertical spatial frequency. u₁(d) is a polynomial fit that adjusts the computed contrast sensitivity function to different pupil diameters d. D takes into account the purely diffraction-limited portion of the contrast sensitivity function. For white light, it is computed with an average wavelength of λ=555 nm.

S takes into account the effect of scattered light. It is a function of the pigmentation factor p and the age a of the observer, as well as the predefined reference age of 70 years. The equations for D, u₁(d), and S(a,p) are present in the publication by Watson ([12], equations (1), (4), (6)).

Lastly, the pupil diameter is computed as stated in Watson et al. [16]. This model is an enhancement of the model created by Stanley and Davies [17], and includes aging effects as well as a distinction between binocular and monocular vision. The model proposed here is considered for binocular vision. This results in the following equation for computing the pupil diameter:

$${d}_{S D} ( L , q ) = 7 \text{.75} - 5.75 ( \frac{{( \frac{L \cdot q}{846} )}^{0.41}}{{( \frac{L \cdot q}{846} )}^{0.41} + 2} ) \qquad ( 2 )$$

The dynamic range of the pupil becomes reduced with age. This is taken into account in the equation by adding an additional term:

$$d ( L , q , a ) = {d}_{S D} ( L , q ) + ( a - {a}_{τ e f} ) \cdot ( 0.02132 - 0.0 \; 09562 \cdot {d}_{S D} ( L , q ) ) \qquad ( 3 )$$

L is the average luminance of the visual field (fov), q is the surface area of the fov, and a is the age of the observer. The reference age a_{ref} is given as 28.58 years.

The implemented neural contrast sensitivity function 3 or neural modulation transfer function was developed by Peli [13]. It was originally applied to natural images or complex settings, and allows a prediction of whether small details in the image are visible to the human observer.

The image is convoluted using various cosine log band pass filters, each having different center frequencies and a bandwidth of one octave. The filters in the spatial frequency range are computed as

$${G}_{k} ( r ) = 0.5 \cdot ( 1 + cos ( π \cdot {log}_{2} r - π \cdot k ) ) \qquad ( 4 )$$

Each filter has a center frequency of 2^{k}, where k is an integer value.

The filters provided here are very similar to the Gabor filters, except that the sum of the filters is equal to 1 [13]. Hubel and Wiesel [18] found that receptive fields have a high degree of similarity to Gabor filter functions. The model is therefore a simplified approach to simulating earlier stages of the visual processing, since it does not take into account effects such as the orientation selectivity, as found by Valois et al. [19].

The image is convoluted separately with each filter, which delivers k results.

$${a}_{k} ( x , y ) = f ( x , y ) * {g}_{k} ( x , y ) \qquad ( 5 )$$

f (x,y) is the image value at the horizontal pixel position x and the vertical pixel position y, gₖ(x,y) is the kth band pass filter function in the spatial range, and * represents the convolution operator. For the model explained by way of example, prior to the filtering the image is increased by one-half the filter size in each direction. The values at the edges of the image are repeated to avoid artificial edge formation. The resolution information of the image is not changed by this method, and after the filtering the image size is reduced back to the original size. This so-called padding avoids ringing artifacts that arise from the discrete Fourier transform, and is a common method for multiplication of filters in the frequency range [20].

Since the model explained by way of example is designed for foveal vision, the visual field is limited to ±2 degrees [8]. The surface area that is necessary to represent a full cycle having the smallest frequency should not exceed this range. In observance of the design rule of the Peli model that the center frequency is 2ⁿ, the smallest frequency f_{c1}=2⁻² cyc/deg is selected. The largest applicable frequency for the design that is used is limited by the Nyquist frequency. Since the luminance images shown here have a resolution of ˜75 pix/deg, the maximum frequency that can be achieved by the Fourier transform is 35 pix/deg. This results in a maximum center frequency of f_{c8}=32 cyc/deg. The resulting frequencies, which have been explicitly selected for application of the model proposed here, are thus given by: 0.5, 1, 2, 4, 8, 16, and 32 cyc/deg.

For photopic lighting environments, it is known that a young, healthy human observer has a maximum resolution of 0.5′ [21]. This corresponds to a resolution of 120 cycles/degrees. In contrast, the highest resolution of the model is set to only one-fourth of this value.

FIG. 2 shows the contrast sensitivity, computed using the model explained by way of example, for various luminances. In a comparison of the maximum contrast sensitivity at 200 cd/m² to the contrast sensitivity of 0.2 cd/m², the maximum sensitivity drops to approximately one-fourth of the value. Thus, the selected resolution is likely sufficient for the model.

In order to take the neural adaptation processes into account, Peli computes the contrast for each channel by dividing the filtered images by an adaptation luminance value. The value is computed by keeping in the image only the frequencies that are below the pass band range of the band pass filter. The band pass-filtered image is then divided by the result:

$${c}_{k} ( x , y ) = \frac{{a}_{k} ( x , y )}{f ( x , y ) * {l}_{k} ( x , y )} \qquad ( 6 )$$

Iₖ(x,y) is the low pass filter in the spatial range that is convoluted with the image.

For each pixel in each contrast image, the computed contrast is compared to the threshold contrast. If the contrast for the given center frequency of the band pass is less than a given threshold value, the information in the bandpass-filtered image at this pixel is discarded by setting the pixel to a value of zero.

$${a}_{k} ( x , y ) = \{ \begin{matrix}f ( x , y ) * g ( x , y ) , & if {c}_{k} ( x , y ) \geq {c}_{thresh} \\ 0 , & else\end{matrix} \qquad ( 7 )$$

Peli uses the measured CSF of each individual observer as the threshold value [22]. After the processing of each band pass-filtered image in this way, the resulting image is reconstructed by summing all filtered and threshold value-controlled images, including the low- and high-frequency residues.

$${f}_{rec} ( x , y ) = {l}_{0} ( x , y ) + {\sum }_{k = 1}^{n - 1} {a}_{k} ( x , y ) + {h}_{n} ( x , y ) \qquad ( 8 )$$

I₀ is the low pass residual and hₙ is the high pass residual.

Even though the results of Peli agree well with his study [23], this method is not directly applicable to the model proposed here. The objective is to develop a general approach, not an approach that is tailored to individuals. For this reason, a model that predicts an average contrast sensitivity function for healthy subjects is used to compute the threshold value.

The surroundings in which headlights are typically used have luminances below 3 cd/m², where the transition between photopic vision and mesopic vision occurs [24]. It is therefore important to select a contrast sensitivity function that is valid for the mesopic vision range. The contrast sensitivity function selected for this model as a threshold function was developed for adaptation luminances between 0.02 cd/m² and 7000 cd/m² [14]. The contrast sensitivity function also contains a separable portion that describes the chromatic contrast sensitivity function. This allows the possible expansion of the model in a later step without having to implement a different threshold function.

Wuerger et al. have developed the model as a continuous function that depends on the surrounding luminance and frequency, and that allows the computation for each average luminance or frequency that is found in the measured luminance distribution. Wuerger et al. validate the model using their own measured data, and also by an appropriate comparison to other published data sets. The authors propose an enhancement of the model that includes the dependency of the contrast sensitivity function on the represented cycle number. This enhancement is not applied here, since the authors state that the data volume for verifying the enhancement is not large enough. The resulting achromatic logarithmic contrast sensitivity function is thus computed as follows:

$${S}_{log 10} ( r , {r}_{max} , b ) = {log}_{10} ( {S}_{max} ) - {( \frac{{log}_{10} ( r ) - {log}_{10} ( {r}_{max} )}{0.5 \cdot {2}^{b}} )}^{2} \qquad ( 9 )$$

r is the radial frequency as used in the preceding paragraphs, rₘₐₓ is the frequency at which the contrast sensitivity function has its maximum value, and Sₘₐₓ is the maximum sensitivity at the value rₘₐₓ. The computations of the values for rₘₐₓ and Sₘₐₓ are present in Wuerger et al, [14], equations (16a, b).

The threshold contrast used for the comparison may then be computed using cₜₕᵣₑₛₕ=10^{S}^{_{log 10}}.

The luminance L used for computing the threshold is the average luminance, which is also used for computing the contrast in (6).

To test the applicability of the model explained by way of example to headlight light patterns, a wide variety of light patterns must be generated. FIG. 3 shows an example of a test setup for recording an image that corresponds to a luminance distribution of the light emanating from a headlight.

A camera 7 is mounted 2 m behind a projector 6 and 1.2 m above a roadway 8. The center of the projector lens is situated 0.64 m above the roadway. The camera 7 and the projector 6 are thus placed in positions that are similar to the position of the headlights and of the driver. In particular, the projector 6 may project a light distribution 9 onto the roadway 8 which may correspond to that of a headlight.

For exemplary tests, a Barco W30 Flex high-power projector, which was calibrated geometrically and with regard to the light intensity (since it obtains 8-bit gray scale values as input data) was used as the projector 6. The maximum luminous flux of the projector 6 is given at 30,000 lumens. For an image size of 1920×1200 pixels and a corresponding visual field (fov) of ±15.03° in the horizontal direction and ±10.05° in the vertical direction, a resolution of the projector 6 of 0.017° vertical and 0.016° horizontal results. The projector 6 was situated in a light channel which allows a stable test environment that is independent of weather and time of day.

The model was tested using measured luminance images. A Techno Team LMK5 Color luminance measuring camera, which generates the luminance images by use of a lens having a focal length of 16 mm and a neutral density filter having a transmission of 7.93%, was used as the camera 7.

A point grid was used to translate the pixel positions into angular coordinates. The midpoint of each point had a spacing of 0.5° in the vertical and in horizontal directions. The midpoint of the points in the luminance image was measured in pixel coordinates, using an image processing algorithm. In a next step the position was linked to the corresponding angle. By bilinear interpolation between the measured points, each pixel in the image obtains an angular coordinate in degrees. After the angular positions of the projector were determined in this way, with knowledge of the distance from the projector midpoint it was possible to compute the angular positions for the camera image.

The light pattern used for the test was generated using a simulated light intensity distribution of a headlight module made up of a high-resolution pixeled light source. The simulation allows each individual pixel to be dimmed and completely switched off.

Three different scenarios were investigated:
1. A dark spot was generated on a uniformly illuminated background by switching off selected pixels. The size of the spot was then changed by switching off neighboring pixels. It was expected that the visibility would improve with increasing size of the dark spot.
2. A light spot was generated on the same background, and the size of the spot was changed in the same way as before. The same basic behavior as for the dark spot was expected.
3. In the last scenario, a complex setting of a typical highway with stationary roadway illumination was generated. The effect of the local adaptation on the resolution was tested. It was expected that the visual acuity would decrease in darker areas.

The first two scenarios were initially projected onto a white screen, not depicted in FIG. 3, located 8.4 m from the projector 6. The screen was then removed, and the same image was projected onto the roadway 8. For the third scenario, the light pattern was projected only onto the roadway 8. For the scenarios shown, the age of the observer was set at 30 years, and the eye color of the observer was assumed to be brown.

In the first scenario, dark spots which varied in size were examined. Spot sizes having a diameter of 0.2°, 0.3°, and 0.4° were generated by dimming neighboring pixels of the light source by differing intensities. The selected simulation resulted in an ambient light intensity of 16,770 cd, and a light intensity of the spot of 11,690 cd. The schematic illustration in FIG. 4 shows an example of several small dark spots 10 and two large dark spots 11.

The luminance images recorded by the camera 7 were filtered using band pass filters having different center frequencies. Band pass filters having small center frequencies respond to spatially larger elements in the image, and vice versa. In particular, band pass filters with 1, 2, and 4 cyc/deg respond most strongly to the image.

For the luminance images filtered in this way, contrasts and threshold contrasts were computed. Since the contrast threshold changes with the frequency, different threshold values were computed for each center frequency. A comparison of the contrast thresholds on the roadway to the contrast threshold on the screen shows that the contrast thresholds change with the luminance. Dark regions have a much higher threshold value.

The smaller the spot size, the greater the blurring between the background and the screen. While part of this effect is attributable to the reduced contrast due to blurring of neighboring pixels, the model still shows the effect, since it is greater in the reconstruction than in the original.

An example of an image that is reconstructed for the projection onto the roadway, using a method according to the invention, is shown in FIG. 5. It is shown that for fairly small spot sizes, the visibility is reduced until the spots are hardly visible or not visible at all. In particular, the small dark spots 10 depicted in FIG. 4 are no longer visible in FIG. 5, whereas the large spots 11 may still be clearly recognized. These results illustrate that the model is usable for the desired field of application.

In the second scenario, light spots of varying sizes were investigated. For assessment of the recognition quality of light spots on a uniformly illuminated background, the same ambient light intensity for the simulated light source was used as in the first scenario. The pixels that generate the spots were set to a lower dimming value (higher intensity) than the surroundings. The light intensity for the light spot was given at 21,490 cd.

The test illustrates that in the reconstructed images, the light spots appeared more blurred and less visible compared to the original image. This corresponds to the observed fact that a light spot is more difficult to distinguish from the surroundings than a dark spot of the same size.

In the third scenario, a complex setting, in particular a fairly complex setting of a typical urban roadway at night, was investigated. A low beam light distribution illuminated the roadway in in the presence of stationary roadway illumination.

It was shown that for regions in the image having low luminances, a much lower resolution of the reconstructed image is observed than for regions with higher luminances. This in turn is consistent with the behavior of the human visual system. The visual acuity of the visual system is reduced in dark surroundings.

Thus, for all three scenarios the qualitative behavior of the model agrees with the expected behavior. This is a very good indicator of the applicability of the model. The advantage of the model is the general applicability for numerous luminance distributions and environments, without the need for a parameter adjustment. By use of the three submodels, effects such as physiological blinding and global as well as local luminance adaptation effects are taken into account in the contrast computation.

### LIST OF LITERATURE REFERENCES

[1] Commission Internationale de l'Eclairage, “An Analytic Model for Describing the Influence of Lighting Parameters upon Visual Performance,” CIE publication 19/2, Vienna, 1981.
[2] H. R. Blackwell, “Contrast thresholds of the humane [sic; human] eye,” Journal of the Optical Society of America, 1946.
[3] C. Blakemore, F. W. Campbell, “On the existence of neurones in the human visual system selectively sensitive to the orientation and size of retinal images,” Journal of Physiology, 203 (1), pp. 237-260, 1969.
[4] M. J. Nadenau, J. Reichel, and M. Kunt, “Wavelet-based color image compression: exploiting the contrast sensitivity function,” IEEE Transactions on Image Processing, 12.1, pp. 58-70, 2003.
[5] N. Yamane, K. Miyata, T. Samejima, T. Hiraoka, T. Kiuchi, F. Okamoto, Y. Hirohara, T. Mihashi, and T. Oshika, “Ocular higher-order aberrations and contrast sensitivity after conventional laser in situ keratomileusis,” Investigative Ophthalmology & Visual Science, 45 (11), pp. 3986-3990, 2004.
[6] K. Joulan, N. Hautiere, and N. Bremond, “Contrast sensitivity function for road visibility estimation on digital images,” Proc. 27th Session of the Commission Internationale de l'Eclairage, 2011.
[7] P. G. J. Barten, “Contrast sensitivity of the human eye and its effects on image quality,” SPIE press, 1999.
[8] S. E. Palmer, Vision Science, Photons to Phenomenology, MIT Press, Cambridge, Massachusetts, 1999.
[9] F. L. Van Nes, J. J. Koenderink, H. Nas, and M. A. Bouman, “Spatiotemporal Modulation Transfer in the Human Eye,” Journal of the Optical Society of America A, 57, 1082-1088, 1967.
[10] B. Hauser, H. Ochsner, and E. Zrenner, “Der “Blendvisus”-Teil 1: Physiologische Grundlagen der Visusänderung bei steigender Testfeldleuchtdichte,” [“Blind visual acuity—Part 1: Physiological principles of the change in vision under increasing test field luminance”], Klinische Monatsblätter für Augenheilkunde (200.02), pp. 105-109, 1992.
[11] N. V. K. Medathati, H. Neumann, G. S. Masson, and P. Kornprobst, “Bio-inspired computer vision: Towards a synergistic approach of artificial and biological vision,” Computer Vision and Image Understanding, Vol. 150, pp. 1-30, 2016.
[12] A. B. Watson, “A formula for the mean human optical modulation transfer function as a function of pupil size,” Journal of Vision, 13.6, 18-18, 2013.
[13] E. Peli, “Contrast in complex images,” Journal of the Optical Society of America A, 7, 10, 2032-2040, 1990.
[14] S. Wuerger, M. Ashraf, M. Kim, J. Martinovic, M. Perez-Ortiz, and R. K. Mantiuk, “Spatio-chromatic contrast sensitivity under mesopic and photopic light levels,” Journal of Vision, 20(4), 2020.
[15] J. K. Ijspeert, T. J. T. P. Van Den Berg, and H. Spekreijse, “An improved mathematical description of the foveal visual point spread function with parameters for age, pupil size and pigmentation,” Vision Research 33 (1), pp. 15-20, 1993.
[16] A. B. Watson and J. I. Yellott, “A unified formula for light-adapted pupil size,” Journal of Vision, 12.10, 12-12, 2012.
[17] P. A. Stanley, and A. K. Davies, “The effect of field of view size on steady-state pupil diameter,” Ophthalmic & Physiological Optics, 15(6), pp. 601-603, 1995.
[18] D. H. Hubel and T. Wiesel, “Receptive fields, binocular interaction, and functional architecture in the cat's visual cortex,” Journal of Physiology, London, 160:106-154, 1962.
[19] R. L. de Valois, D. G. Albrecht, and L. G. Thorell, “Spatial frequency selectivity of cells in macaque visual cortex,” Vision Research, 22(5), pp. 545-559, 1982.
[20] A. Distante and C. Distante, Handbook of Image Processing and Computer Vision, Volume 1: From Energy to Image, p. 438, Springer International Publishing, 2020.
[21] J. A. Ferwerda, “Elements of early vision for computer graphics,” IEEE Computer Graphics and Applications 21.5, pp. 22-33, 2001.
[22] E. Peli, “Test of a model of foveal vision by using simulations,” Journal of the Optical Society of America A, 13.6, 1131-1138, 1996.
[23] E. Peli, “Contrast sensitivity function and image discrimination,” Journal of the Optical Society of America A, 18, 283-293, 2001.
[24] B. Wördenweber, P. Boyce, D. D. Hoffmann and J. Wallaschek, “Automotive lighting and human vision,” Vol. 1, Springer-Verlag, Berlin Heidelberg, 2007.

### LIST OF REFERENCE NUMERALS

1 digital image
2 optical contrast sensitivity function
3 neural contrast sensitivity function
4 threshold value contrast sensitivity function
5 altered image
6 projector
7 camera
8 roadway
9 light distribution
10 small dark spot
11 large dark spot

1. A method for analyzing a luminance distribution of the light emanating from a lighting device for a vehicle, the method comprising:
recording a digital image that corresponds to a luminance distribution of the light emanating from a lighting device of a vehicle; and
modifying the digital image in such a way that the modified image is a reconstruction of the luminance distribution in which at least essentially only the elements or portions of the luminance distribution that are perceivable by a human are contained.

2. The method according to claim 1, wherein the digital image is modified using an algorithm that simulates processing steps of the human visual system.

3. The method according to claim 2, wherein the algorithm, in particular in a first step, simulates the change in an image due to the optical structure of a human eye.

4. The method according to claim 1, wherein the algorithm, in particular in a second step, simulates the processing of image information concerning contrast information, which is performed in particular by the human brain or by cell types in the retina.

5. The method according to claim 2, wherein the algorithm, in particular in a third step, determines a visibility threshold.

6. The method according to claim 5, wherein the visibility threshold is used to decide which elements or portions of the luminance distribution are perceivable by a human and which elements or portions of the luminance distribution are not perceivable by a human, wherein the elements or portions of the luminance distribution that are not perceivable by a human according to this decision are not incorporated into the modified image.

7. The method according to claim 1, wherein the modified digital image is compared to an image generated from a setpoint luminance distribution of the lighting device, in particular to decide whether the light distribution that is generated by the lighting device corresponds to suitable specifications, taking into account the perceivability by a human.

8. The method according to claim 1, wherein the recording of the digital image is a luminance measurement or is converted into a luminance distribution.

9. The method according to claim 1, wherein the lighting device is a taillight or a headlight, in particular a high-resolution headlight, that can generate a light distribution having a plurality of pixels.

10. The method according to claim 1, wherein the recorded digital image is a recording of a headlight light distribution or a recording of a taillight.
